(19) United States
(12) Patent Application Publication
(10) Pub. No.: US 2017/0277157 A1
(43) Pub. Date: Sep. 28, 2017

(54) ENGINEERING TOOL PROGRAM AND ENGINEERING TOOL

(71) Applicant: Mitsubishi Electric Corporation, Tokyo (JP)

(72) Inventor: Takayuki YAMAOKA, Tokyo (JP)

(73) Assignee: Mitsubishi Electric Corporation, Tokyo (JP)

(21) Appl. No.: 15/528,560

(22) PCT Filed: Jan. 22, 2015
(86) PCT No.: PCT/JP2015/051689

§ 371 Date: May 22, 2017

(51) Int. Cl. G05B 19/042; G05B 19/05

(52) U.S. Cl. CPC G05B 19/0426; G05B 19/05; G05B 2219/14008

(57) ABSTRACT

An engineering tool program causes a computer function as a content-data storing section that stores data in which content classes indicating classifications of content data to be displayed by an engineering tool and types of monitor screens that display the content data are associated, a content-relation managing section that stores content relation management data indicating a hierarchical relation of layers among different content classes, and a display control section that changes, when detecting that first operation is performed, a monitor screen being displayed to a monitor screen corresponding to a content class of an immediately subordinate layer on the basis of the content relation management data and changes, when detecting that second operation is performed, the monitor screen being displayed to a monitor screen corresponding to a content class of an immediately superordinate layer on the basis of the content relation management data.

### FIELD

The present invention relates to an engineering tool program and an engineering tool for improving efficiency of monitoring and debugging work for a sequence program.

### BACKGROUND

An engineering tool for a programmable logic controller for improving efficiency of monitoring and debugging work for a sequence program includes a unit configuration function for implementing a control system by a programmable logic controller, a parameter setting function, a sequence-program creating function, and a sequence-program monitoring function. The engineering tool is realized by causing a computer to execute an engineering tool program. Units are devices configuring the programmable logic controller that forms the control system. Specific examples of the units include a CPU (Central Processing Unit), an input unit, an output unit, and an analog unit. The programmable logic controller is configured by a plurality of units. The sequence program is a program for operating the control system. In the engineering tool, it is possible to create and monitor a plurality of sequence programs.

By using unit variables, which are variables indicating states of the units configuring the programmable logic controller, in the sequence program, it is possible to control states of the units. A user can execute the functions using display screens peculiar to the functions. The display screens peculiar to the functions are unit configuration diagrams, variable list screens, or programmable editors.

In debugging work at the time when a deficiency occurs in the sequence program that is operating the units, in the conventional engineering tool, when the user desires to monitor programs or unit variables related to the units, the user needs to perform operation explained below.

In a first procedure, the user specifies a unit in which the deficiency has occurred. In a second procedure, the user identifies a unit variable related to the unit specified in the first procedure. In a third procedure, the user searches for a program used by the unit variable identified in the second procedure, displays the program, and monitors a state.

Patent Literature 1 discloses a technique for performing enlarged display operation for an icon, which is a display component displayed on a screen, to thereby display contents, which are information related to the display component.

### CITATION LIST

### Patent Literature

Patent Literature 1: Japanese Patent Application Laid-Open No. 2014-130650

### SUMMARY

### Technical Problem

However, according to the conventional technology, association between the icon, which is the selected display component, and content data to be switched by zoom-in and zoom-out operation, which is operation for changing a display region, is based on link setting among the content data. Therefore, the user has to perform work for setting a link for each of the content data. As an example, when a unit is added to a control system configuration, for display switching, it is necessary to set links among content data used in the added unit.

The present invention has been devised in view of the above and an object of the present invention is to obtain an engineering tool program with which a user can perform association of display switching without explicitly setting links among content data.

### Solution to Problem

To solve the problems and achieve the object, the present invention provides an engineering tool program for causing a computer to function as an engineering tool that monitors a programmable logic controller configured by a plurality of units and forming a control system, the engineering tool program causing the computer to function as: a content-data storing section to store data in which content classes indicating classifications of content data to be displayed by the engineering tool and types of monitor screens that display the content data are associated; a content-relation managing section to store content relation management data indicating a hierarchical relation of layers among different content classes; and a display control section to change, when detecting that first operation is performed, a monitor screen being displayed to a monitor screen corresponding to a content class of an immediately subordinate layer on the basis of the content relation management data and change, when detecting that second operation is performed, the monitor screen being displayed to a monitor screen corresponding to a content class of an immediately superordinate layer on the basis of the content relation management data.

### Advantageous Effects of Invention

The engineering tool program according to the present invention achieves an effect that a user can perform association of display switching without explicitly setting links among content data.

### BRIEF DESCRIPTION OF DRAWINGS

FIG. 1 is a diagram showing the configuration of an engineering tool according to a first embodiment of the present invention.

FIG. 2 is a diagram showing the configuration of a computer applied to the engineering tool according to the first embodiment.

FIG. 3 is a diagram showing a functional configuration of the engineering tool according to the first embodiment.

FIG. 4 is a diagram showing an example of a unit configuration diagram used for display of units by the engineering tool according to the first embodiment.

FIG. 5 is a diagram showing an example of a variable list screen used for display of unit variables by the engineering tool according to the first embodiment.

FIG. 6 is a diagram showing an example of a program editor used for display of a sequence program by the engineering tool according to the first embodiment.

FIG. 7 is a diagram showing an example of a unit library of the engineering tool according to the first embodiment.

FIG. 8 is a diagram showing an example of content relation management data of the engineering tool according to the first embodiment.

FIG. 9 is a diagram showing an example of content data stored in a content-data storing section of the engineering tool according to the first embodiment.

FIG. 10 is a diagram showing an example of content data stored in the content-data storing section of the engineering tool according to the first embodiment.

FIG. 11 is a flowchart showing a flow of processing in which a display control section determines a screen displayed on a display device in the engineering tool according to the first embodiment.

FIG. 12 is a diagram showing screen transition of the engineering tool according to the first embodiment.

FIG. 13 is a diagram showing a functional configuration of an engineering tool according to a second embodiment of the present invention.

FIG. 14 is a diagram showing screen transition of the engineering tool according to the second embodiment.

FIG. 15 is a diagram showing a functional configuration of an engineering tool according to a third embodiment of the present invention.

FIG. 16 is a diagram showing a concept of the operation of a content-relation-order setting section included in the engineering tool according to the third embodiment.

FIG. 17 is a diagram showing content relation management data at the time when the content-relation-order setting section of the engineering tool according to the third embodiment sets selected content classes selected by zoom-in operation to the order of a unit, a sequence program, and a unit variable.

FIG. 18 is a diagram showing screen transition of the engineering tool according to the third embodiment.

### DESCRIPTION OF EMBODIMENTS

Engineering tool programs and engineering tools according to embodiments of the present invention are explained in detail below with reference to the drawings. Note that the present invention is not limited by the embodiments.

### First Embodiment

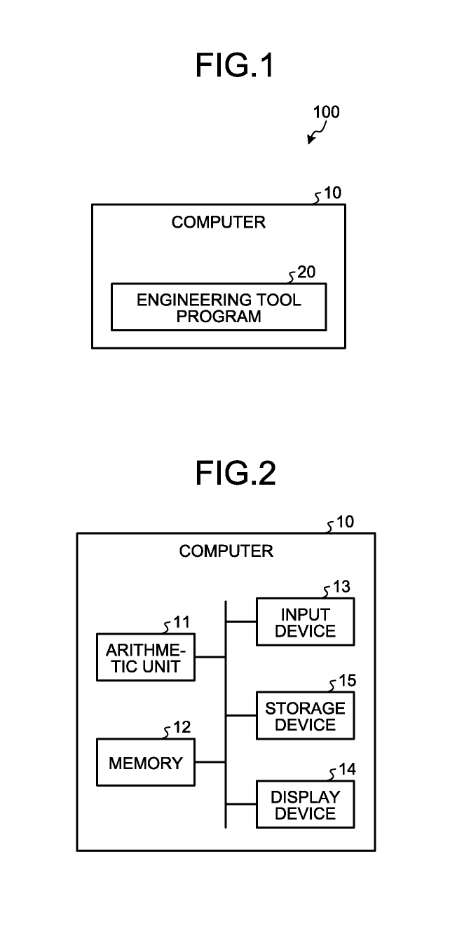

FIG. 1 is a diagram showing the configuration of an engineering tool according to a first embodiment of the present invention. An engineering tool 100 is configured by installing an engineering tool program 20 in a computer 10. In other words, the computer 10 that is executing the engineering tool program 20 functions as the engineering tool 100.

FIG. 2 is a diagram showing the configuration of the computer applied to the engineering tool according to the first embodiment. The computer 10 includes an arithmetic unit 11 that executes a program, a memory 12 used as a work area by the arithmetic unit 11, an input device 13, which is a user interface on which a user performs input operation, a display device 14 that displays information, and a storage device 15 that stores the engineering tool program 20 and the information. Note that the display device 14 can be externally attached to the computer 10. The arithmetic unit 11 reads out the engineering tool program 20 from the storage device 15 and executes the engineering tool program 20, whereby a plurality of functional sections are configured on the computer 10.

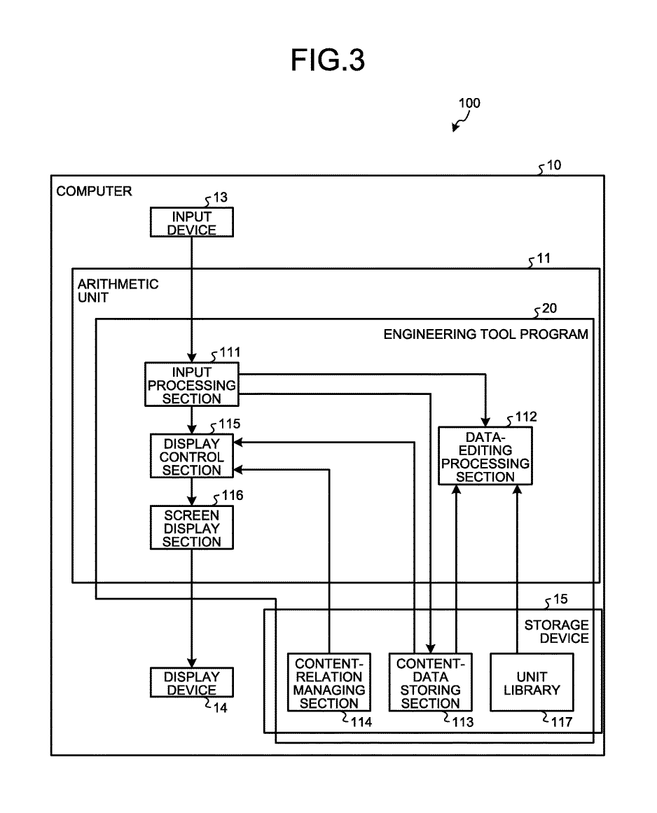

FIG. 3 is a diagram showing a functional configuration of the engineering tool according to the first embodiment. On the arithmetic unit 11, an input processing section 111 that recognizes operation on the input device 13 and allocates processing, a data-editing processing section 112 that updates data in a content-data storing section 113 explained below, a display control section 115 that determines a monitor screen to be displayed and content data on the basis of an output of the input processing section 111, and a screen display section 116 that switches a screen displayed on the display device 14 are formed. In the storage device 15, a content-data storing section 113, which is a database in which content data is stored, a content-relation managing section 114 that stores content relation management data indicating a hierarchical relation of layers among different content classes, and a unit library 117 that stores information indicating which unit has which unit variable are formed. Note that a variable name is set in advance in the unit variable.

The input processing section 111, the data-editing processing section 112, the content-data storing section 113, the content-relation managing section 114, the display control section 115, the screen display section 116, and the unit library 117 shown in FIG. 3 are realized by the arithmetic unit 11 executing the engineering tool program 20. Note that a plurality of arithmetic units and a plurality of memories can execute the functions in cooperation with each other.

The content data is a general term of specific data displayed by the engineering tool 100. The content data are added and deleted in the engineering tool 100 when a control system by a programmable logic controller is constructed. The content data have states or values and can be displayed on the display device 14 by a monitor function of the engineering tool 100.

The content classes are classifications of the content data. In the first embodiment, it is assumed that there are three kinds of content classes of a “unit” indicating a type of a unit configuring the programmable logic controller, a “unit variable” indicating an internal state of the unit, and a “sequence program” executed by the programmable logic controller. In the first embodiment, it is assumed that a monitor screen of a different screen type is used for each of the content classes.

When detecting that first operation is performed, the display control section 115 instructs the screen display section 116 to change a monitor screen being displayed on the display device 14 to a monitor screen corresponding to a content class of an immediately subordinate layer on the basis of the content relation management data. When detecting that second operation is performed, the display control section 115 instructs the screen display section 116 to change the monitor screen being displayed on the display device 14 to a monitor screen corresponding to a content class of an immediately superordinate layer on the basis of the content relation management data.

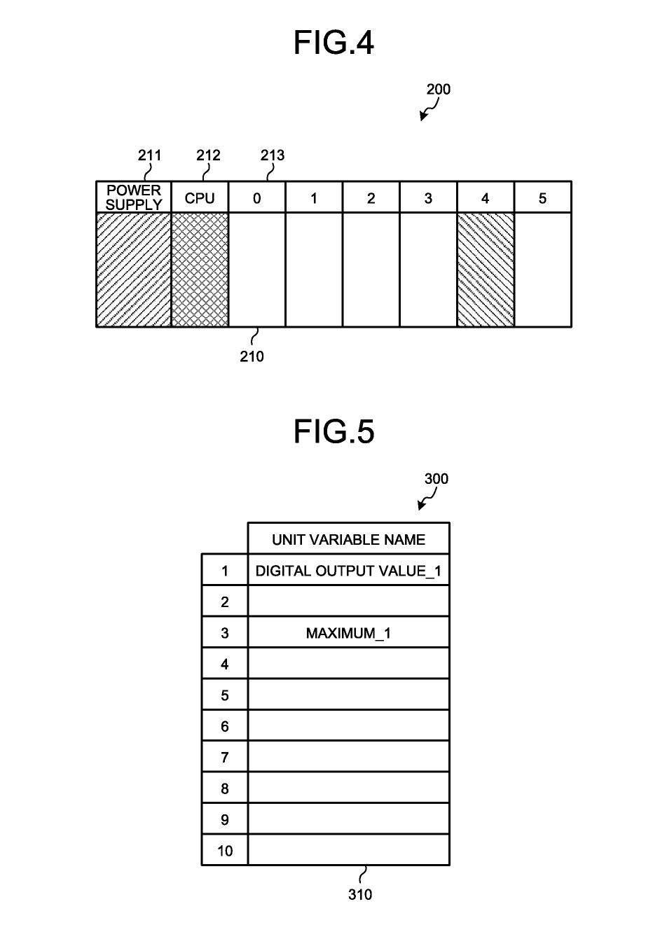

FIG. 4 is a diagram showing an example of a unit configuration diagram used for display of units by the engineering tool according to the first embodiment. A unit configuration diagram 200 shown in FIG. 4 is a monitor screen displayed simulating a unit configuration of a programmable logic controller 210 that forms a control system. The unit configuration diagram 200 graphically shows types of units attached to a power-supply-unit slot 211, a CPU-unit slot 212, and a general-purpose slot 213.

FIG. 5 is a diagram showing an example of a variable list screen used for display of unit variables by the engineering tool according to the first embodiment. A variable list screen 300 displays a list 310 of unit variables using a table including a plurality of rows.

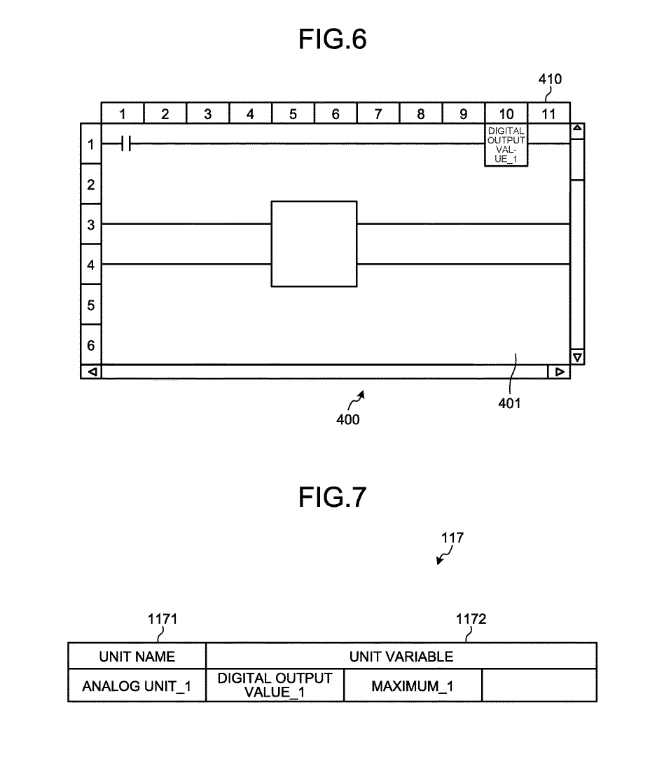

FIG. 6 is a diagram showing an example of a program editor used for display of a sequence program by the engineering tool according to the first embodiment. A program editor 400 editably displays a sequence program 410 in a matrix-like editor region 401 including pluralities of rows and columns.

In the unit configuration diagram 200, the variable list screen 300, and the program editor 400, “display components” are used to display the content data on the monitor screen. The display components can be identified for each of the content data on the monitor screen. The unit configuration diagram 200, the variable list screen 300, and the program editor 400 can display, select, zoom in, zoom out, and monitor the display components. Note that the monitoring of the display components means dynamically displaying states of the display components on the basis of operation data of the programmable logic controller 210.

FIG. 7 is a diagram showing an example of the unit library of the engineering tool according to the first embodiment. The unit library 117 is a data structure in which a unit name 1171 and a unit variable 1172 are associated. In the unit library 117 shown in FIG. 7, it is indicated that a unit having a name of analog unit_1 has two unit variables of a digital output value_1 and a maximum_1. Data of the unit library 117 is added when a unit is added to the unit configuration. Variable types of the units are determined in advance for the units. In the case of an analog unit, the variable types are a “digital output value” and a “maximum”. When a unit is added, an identifier unique in the programmable logic controller is added to a variable type name of the unit and variable names are added to the unit library. As a specific example, when a first analog unit is added, the variable names are “digital output value_1” and “maximum_1”.

The input processing section 111 recognizes an operation performed on the input device 13 and notifies the data-editing processing section 112 and the display control section 115 of a selected display component and operation content. When the operation on the input device 13 is operation of zoom-in or zoom-out, the input processing section 111 notifies the display control section 115 of the operation content. When the operation on the input device 13 is addition, change, or deletion of content data, the input processing section 111 notifies the data-editing processing section 112 of the operation content.

A specific example of the operation of the zoom-in and the zoom-out is operation by an operator for rotating a mouse wheel of a mouse, which is a part of the input device 13, while depressing a control key on a keyboard, which is a part of the input device 13. A rotation amount of the mouse wheel is an operation amount indicating magnification of the zoom-in or the zoom-out. However, the operation of the zoom-in and the zoom-out is not limited to the depression of the control key and the rotation of the mouse wheel. As an example, if the input device 13 is a keyboard, the input processing section 111 can recognize depression of a control key and a cursor key as the zoom-in operation or the zoom-out operation. If the input device 13 is a touch panel, the input processing section 111 can recognize that operation by pinch, stretch, slide, or swipe as the zoom-in operation or the zoom-out operation. If the input device 13 is a microphone, the input processing section 111 can recognize operation by a sound input as the zoom-in operation and the zoom-out operation.

When being notified from the input processing section 111 that input operation for adding, changing, or deleting content data is performed, the data-editing processing section 112 adds the content data to the content-data storing section 113 or changes or deletes the content data in the content-data storing section 113 to thereby update the data in the content-data storing section 113.

The display control section 115 performs processing for enlarging or reducing a display screen when being notified from the input processing section 111 that the operation of the zoom-in or the zoom-out is performed. When a zoom operation amount exceeds a threshold of the zoom operation amount, the display control section 115 switches, on the basis of the content relation management data stored in the content-relation managing section 114, a screen displayed on the display device 14.

The content relation management data stored in the content-relation managing section 114 is stored in the storage device 15 when the engineering stool 100 is started, in other words, when the engineering tool program 20 is executed.

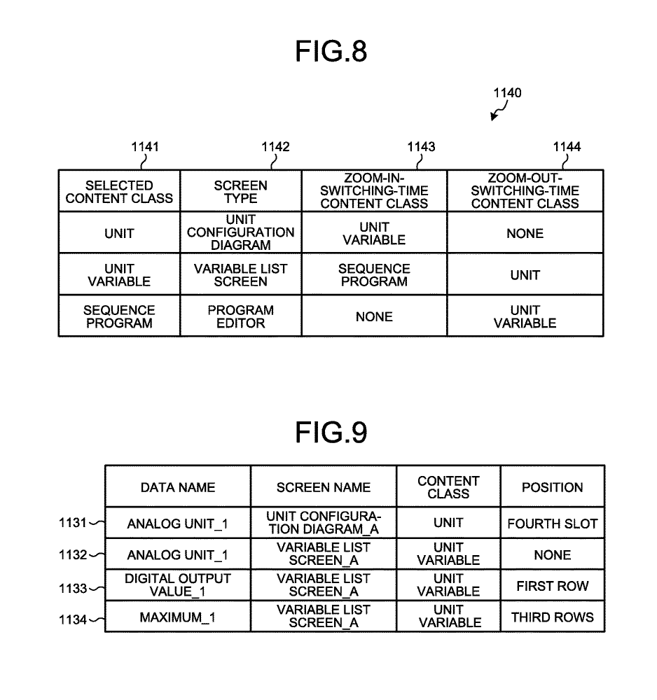

FIG. 8 is a diagram showing an example of the content relation management data of the engineering tool according to the first embodiment. A content relation management data 1140 is data in which a selected content class 1141 indicating a content class displayed on a present monitor screen, a screen type 1142 indicating a type of the present monitor screen, a zoom-in-switching-time content class 1143 indicating a content class set as a switching destination when first operation is performed on the input device 13, and a zoom-out-switching-time content class 1144 indicating a content class set as a switching destination when second operation is performed on the input device 13 are associated. As an example, when a content class currently displayed on a display screen is a unit variable, the display screen displayed on the display device 14 is a variable list screen. The content class set as the switching destination when the first operation is performed on the input device 13 is a sequence program. The content class set as the switching destination when the second operation is performed on the input device 13 is a unit.

On the other hand, content data is not stored n the content-data storing section 113 when the engineering tool 100 is started. A unit to be used in the control system is registered by operation on the input device 13 and a sequence program is created, whereby content data is stored in the content-data storing section 113.

First, an example of operation for registering a unit used in the control system is explained. It is assumed that a creation screen of the unit configuration diagram 200 is opened, a name “unit configuration diagram_A” is set in the unit configuration diagram 200, and operation for adding an analog unit having a name “analog unit_1” to a fourth slot is performed. The input processing section 111 recognizes that, in operation on the input device 13, a selected display component is the analog unit_1, a position is the fourth slot, and operation content is addition. Because the operation is operation for adding content data, the input processing section 111 notifies the data-editing processing section 112 of the operation content.

The data-editing processing section 112 acquires, referring to the unit library 117 on the basis of the operation content notified from the input processing section 111, a unit variable of the analog unit_1. It is assumed that the data shown in FIG. 7 is stored in the unit library 117 and the analog unit_1 has two unit variables of a digital output value and a maximum. The data-editing processing section 112 causes the content-data storing section 113 to store the content notified from the input processing section 111, that is, content data corresponding to the operation content indicating that the analog unit having the name of analog unit_1 is added to the fourth slot in the unit configuration diagram_A, the content class of which is the unit. The data-editing processing section 112 causes the content-data storing section 113 to store the content data indicating the unit variable of the analog unit_1.

FIG. 9 is a diagram showing an example of content data stored in the content-data storing section of the engineering tool according to the first embodiment. Content data 1131 in a first row is a record corresponding to operation content for arranging a unit having a name of analog unit_1 in the fourth slot in the unit configuration diagram_A. Content data 1132 in a second row is a record corresponding to registration in the unit library 117 indicating that the analog unit_1 has a unit variable. Content data 1133 in a third row and content data 1134 in a fourth row are records corresponding to the unit variable registered in the unit library 117.

An example of operation for creating a sequence program is explained. It is assumed that the program editor 400 shown in FIG. 6 is opened, a name of program editor_A is set, and a program in which a unit variable digital output value_1 of the analog unit_1 is used in a tenth column of a first row is added. The input processing section 111 recognizes that, in operation on the input device 13, a selected display component is the digital output value_1, a position is the tenth column of the first row, and operation content is addition. Because the operation is operation for adding content data, the input processing section 111 notifies the data-editing processing section 112 of operation content.

The data-editing processing section 112 causes the content-data storing section 113 to store the content notified from the input processing section 111, that is, content data indicating that the unit variable having the name of digital output value_1 is added to the tenth column of the first row in the program editor_A, the content class of which is a monitor screen of the sequence program.

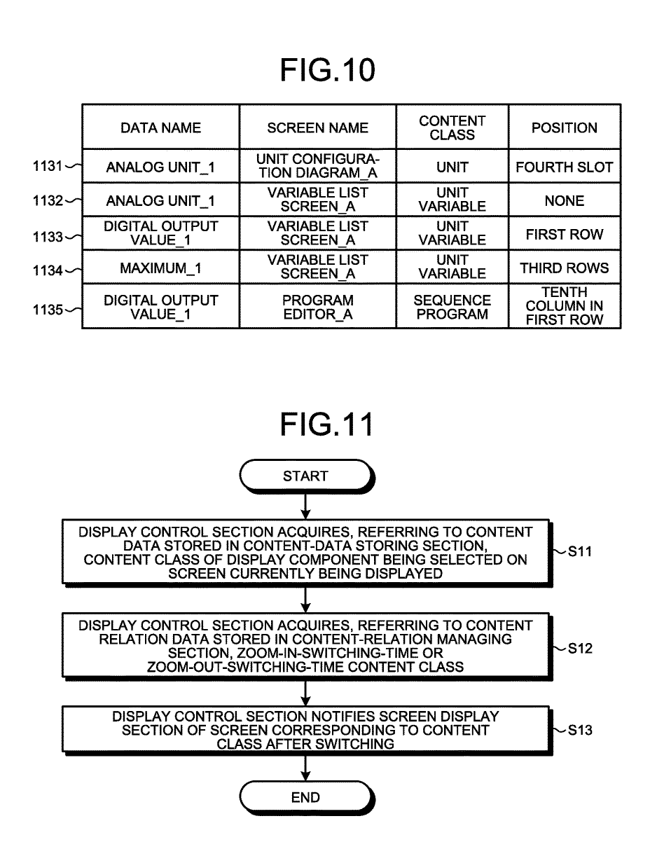

FIG. 10 is a diagram showing an example of content data stored in the content-data storing section of the engineering tool according to the first embodiment. When content data during unit registration is stored in the content-data storing section 113, content data is additionally recorded in the content-data storing section 113 when a sequence program is created. The content data 1131 in the first row to the content data 1134 in the fourth row are records that the data-editing processing section 112 causes the content-data storing section 113 to store during unit addition. Content data 1135 in a fifth row is a record corresponding to operation for arranging a unit variable having a name of digital output value_1 in a tenth column of a first row in the program editor_A.

Operation for switching a monitor screen displayed on the display device 14 is explained. It is assumed that first operation is zoom-in operation having an operation amount equal to or larger than a first threshold set in advance and second operation is zoom-out operation having an operation amount equal to or larger than a second threshold set in advance. By defining the first operation and the second operation in this way, it is possible to switch the monitor screen according to the zoom-in operation having the operation amount equal to or larger than the first threshold or the zoom-out operation having the operation amount equal to or larger than the second threshold. When the input processing section 111 detects that the first operation or the second operation is performed on the input device 13, the display control section 115 performs processing explained below and notifies the screen display section 116 of a screen type after the switching. The screen display section 116 changes, according to the notification from the display control section 115, the monitor screen displayed on the display device 14.

FIG. 11 is a flowchart showing a flow of processing in which the display control section determines a screen displayed on the display device in the engineering tool according to the first embodiment. At step S11, the display control section 115 acquires, referring to the content data stored in the content-data storing section 113, a content class of a display component being selected on a screen currently being displayed. At step S12, the display control section 115 acquires, referring to the content relation management data stored in the content-relation managing section 114, a content class during zoom-in switching or during zoom-out switching. At step S13, the display control section 115 notifies the screen display section 116 of a screen corresponding to a content class after the switching.

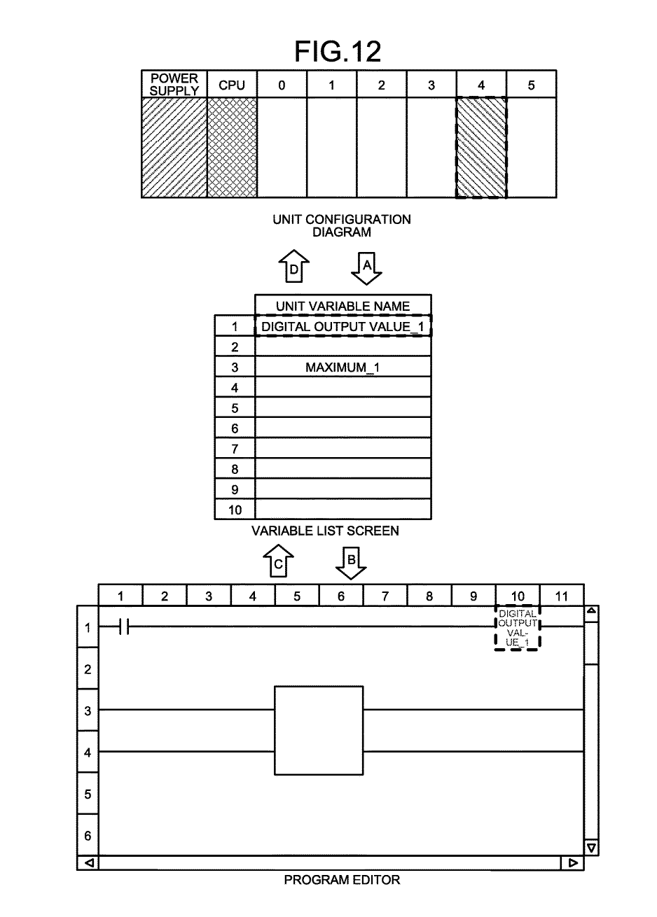

The operation for switching the screen displayed on the display device 14 is explained with reference to a specific example. FIG. 12 is a diagram showing screen transition of the engineering tool according to the first embodiment. It is assumed that a deficiency is detected in the analog unit_1 during an operation check of a sequence program created by the program editor_A. The user starts monitoring of a system to examine the deficiency.

The user performs, on the input device 13, operation for opening the unit configuration diagram_A and causes the display device 14 to display the unit configuration diagram_A. The user refers to the unit configuration diagram_A displayed on the display device 14 and confirms that an abnormality has occurred in the analog unit_1 of the fourth slot. Note that, in FIG. 12, the occurrence of the abnormality in the analog unit_1 is indicated by surrounding the analog unit_1 with a broken line in the unit configuration diagram_A.

When operation having an operation amount equivalent to zoom-in of 200% is performed on the input device 13 in a state in which the analog unit_1 is selected on the unit configuration diagram_A, the input processing section 111 recognizes that the selected display component is the analog unit_1 and the operation content is the zoom-in of 200%. Because the operation content is the zoom-in operation, the input processing section 111 notifies the display control section 115 of the operation content.

It is assumed that the first threshold for the zoom-in display switching is set in advance to an operation amount equivalent to magnification of 200%. Because the operation amount in the zoom-in operation is equal to or larger than the operation amount equivalent to the magnification of 200%, which is the first threshold set in advance, the display control section 115 determines a zoom-in display switching screen of the selected analog unit_1 according to the following procedure and notifies the screen display section 116 of the zoom-in display switching screen.

The display control section 115 acquires, referring to the content data stored in the content-data storing section 113, a unit of a content class of the analog unit_1 in the unit configuration diagram_A. The display control section 115 acquires, referring to the content relation management data stored in the content-relation managing section 114, a unit variable, a content class of which is a zoom-in-switching-time content class of the unit. The display control section 115 acquires, referring to the content data stored in the content-data storing section 113, a variable list screen_A, a data name of which is analog unit_1 and a content class of which is a screen name of the unit variable. The display control section 115 notifies the screen display section 116 that a screen name after switching is the variable list screen_A.

The screen display section 116 notified of the screen name after the switching from the display control section 115 switches the screen displayed on the display device 14 from the unit configuration diagram_A to the variable list screen_A. That is, the screen display section 116 changes the monitor screen from the unit configuration diagram_A to the variable list screen_A and causes screen transition indicated by an arrow A in FIG. 12.

Note that, when an operation amount in the zoom-in operation is the operation amount equivalent to magnification smaller than 200%, the display control section 15 outputs information designating the unit configuration diagram_A being displayed on the display device 14 and the operation amount in the zoom-in operation to the display control section 115. The screen display section 16 enlarges and displays the unit configuration diagram_A at the magnification corresponding to the operation amount notified from the display control section 115.

It is assumed that, on the variable list screen_A displayed in the operation explained above, it is indicated that a value of the unit variable of the digital output value_1 is abnormal. Note that, in FIG. 12, occurrence of the abnormality in the digital output value_1 is indicated by surrounding the digital output value_1 with a broken line in the variable list screen_A. When the zoom-in operation is performed on the input device 13 in a state in which a row of the digital output value_1 is selected on the variable list screen_A, the input processing section 111 recognizes that the selected display component is the digital output value_1 and the operation content is the zoom-in of 200%. Because the operation content is the zoom-in operation, the input processing section 111 notifies the display control section 115 of the operation content.

It is assumed that the first threshold for the zoom-in display switching is set in advance to an operation amount equivalent to magnification of 200%. Because the operation amount in the zoom-in operation is equal to or larger than the operation amount equivalent to the magnification of 200%, which is the first threshold set in advance, the display control section 115 determines a zoom-in display switching screen of the selected analog unit_1 according to the following procedure and notifies the screen display section 116 of the zoom-in display switching screen.

A procedure in which the display control section 115 determines a zoom-in display switching screen is explained. The display control section 115 acquires, referring to the content data stored in the content-data storing section 113, a unit variable of a content class in the variable list screen_A of the digital output value_1. The display control section 115 acquires, referring to the content relation management data stored in the content-relation managing section 114, a sequence program, a content class of which is a zoom-in-switching-time content class of the unit variable. The display control section 115 acquires, referring to the content data stored in the content-data storing section 113, the program editor_A, a data name of which is digital output value_1 and a content class of which is a screen name of the sequence program. The display control section 115 notifies the screen display section 116 that a screen name after switching is the program editor_A.

The screen display section 116 notified of the screen name after the switching from the display control section 115 switches the screen displayed on the display device 14 from the variable list screen_A to the program editor_A. That is, the screen display section 116 changes the monitor screen from the variable list screen_A to the program editor_A and causes screen transition indicated by an arrow B in FIG. 12. Note that, in FIG. 12, to represent that an abnormality has occurred, display of the digital output value_1 in the program editor_A is indicated by surrounding the analog unit_1 with a broken line.

Note that, when the operation amount in the zoom-in operation is an operation amount equivalent to magnification smaller than 200%, the display control section 15 outputs information for designating the variable list screen_A being displayed on the display device 14 and the operation amount in the zoom-in operation to the display control section 115. The screen display section 16 enlarges and displays the variable list screen_A at the magnification corresponding to the operation amount notified from the display control section 115.

When the zoom-out operation having an operation amount of 50% is performed on the input device 13 in a state in which the digital output value_1 is selected on the program editor_A, the input processing section 111 recognizes that the operation content is the zoom-out and the operation amount is 50%. Because the operation content is the zoom-out operation, the input processing section 111 notifies the display control section 115 of the operation content.

It is assumed that the second threshold of the zoom-out display switching is set in advance to the operation amount equivalent to the magnification of 50%. Because the operation amount in the zoom-out operation is equal to or larger than the operation amount equivalent to the magnification of 50%, which is the second threshold set in advance, the display control section 115 determines a zoom-out display switching screen of the selected digital output value_1 according to the following procedure and notifies the screen display section 116 of the zoom-out display switching screen. Note that, in the case of the zoom-out operation, the operation amount is larger as the magnification is smaller.

A procedure in which the display control section 115 determines the zoom-out display switching screen of the selected digital output value_1 is explained. The display control section 115 acquires, referring to the content data stored in the content-data storing section 113, a sequence program of a content class in the program editor_A of the digital output value_1. The display control section 115 acquires, referring to the content relation management data stored in the content-relation managing section 114, a unit variable, a content class of which is a zoom-out-switching-time content class of the sequence program. The display control section 115 acquires, referring to the content data stored in the content-data storing section 113, the variable list screen_A, a data name of which is digital output value_1 and a content class of which is a screen name of the unit variable. The display control section 115 notifies the screen display section 116 that a screen name after switching is the variable list screen_A.

The screen display section 116 notified of the screen name after the switching from the display control section 115 switches a screen to be displayed on the display device 14 from the program editor_A to the variable list screen_A. That is, the screen display section 116 changes the monitor screen from the program editor_A to the variable list screen_A and causes screen transition indicated by an arrow C in FIG. 12.

Note that, when the operation amount in the zoom-out operation is an operation amount equivalent to magnification smaller than 50%, the display control section 15 outputs information for designating the program editor_A being displayed on the display device 14 and the operation amount in the zoom-in operation to the display control section 115. The screen display section 16 reduces and displays the program editor_A at the magnification corresponding to the operation amount notified from the display control section 115.

When the zoom-out operation having the operation amount of 50% is performed on the input device 13 on the variable list screen_A, the input processing section 111 recognizes that an operation content is the zoom-out and an operation amount is 50%. Because the operation content is the zoom-out operation, the input processing section 111 notifies the display control section 115 of the operation content.

As in the above explanation, it is assumed that the second threshold of the zoom-out display switching is set in advance to the operation amount equivalent to the magnification of 50%. Because the operation amount in the zoom-out operation is equal to or larger than the operation amount equivalent to the magnification of 50%, which is the second threshold set in advance, the display control section 115 determines a zoom-out display switching screen of the selected analog unit_1 according to the following procedure and notifies the screen display section 116 of the zoom-out display switching screen.

A procedure in which the display control section 115 determines the zoom-out display switching screen of the selected analog unit_1 is explained. The display control section 115 acquires, referring to the content data stored in the content-data storing section 113, a unit variable of a content class in the variable list screen_A of the analog unit_1. The display control section 115 acquires, referring to the content relation management data stored in the content-relation managing section 114, a unit, a content class of which is a zoom-out-switching-time content class of the unit variable. The display control section 115 acquires, referring to the content data stored in the content-data storing section 113, the unit configuration diagram_A, a data name of which is analog unit_1 and a content class of which is a screen name of the unit. The display control section 115 notifies the screen display section 116 that a screen name after switching is the unit configuration diagram_A.

The screen display section 116 notified of the screen name after the switching from the display control section 115 switches a screen to be displayed on the display device 14 from the variable list screen_A to the unit configuration diagram_A. That is, the screen display section 116 changes the monitor screen from the variable list screen_A to the unit configuration diagram_A and causes screen transition indicated by an arrow D in FIG. 12.

Note that, when the operation amount in the zoom-out operation is an operation amount equivalent to magnification smaller than 50%, the display control section 15 outputs information for designating the variable list screen_A being displayed on the display device 14 and the operation amount in the zoom-in operation to the display control section 115. The screen display section 16 reduces and displays the variable list screen_A at the magnification corresponding to the operation amount notified from the display control section 115.

When the user desires to monitor a program or a unit variable related to a unit, the conventional engineering tool for the programmable logic controller requires time for, for example, searching for and displaying a target program using a search function. To solve the problem, the engineering tool 100 according to the first embodiment enables the user to, without directly setting links among contents, perform, through a unit variable representing an internal state of a unit, display switching of a monitor screen from a unit configuration of a control system to a sequence program, in which the unit variable is used, with single operation on the engineering tool and without moving a mouse cursor to a menu or a project configuration list or a tab. Consequently, because display switching of the monitor screen of the sequence program can be executed with less operation, it is possible to reduce debugging operation man-hour. Because the display switching can be quickly performed even when a computer including a small display device is applied to the engineering tool, there is an effect that it is possible to improve debugging work efficiency on a site. Note that examples of the computer including the small display device include a tablet terminal.

With the engineering tool according to the first embodiment, during unit addition and during program editing, the user can perform association of display switching without explicitly setting links among content data. That is, the user does not need to explicitly set links among units configuring the programmable logic controller, unit variables indicating internal states of the units, and a sequence program executed by the programmable logic controller. With the engineering tool 100 according to the first embodiment, the user can change the monitor screen with simple operation of the zoom-in operation having the operation amount equal to or larger than the first threshold or the zoom-out operation having the operation amount equal to or larger than the second threshold. Consequently, it is possible to reduce work time for construction and operation of a control system by the programmable logic controller.

In the above explanation, the processing for switching the monitor screen when the operation amount of the zoom-in operation or the zoom-out operation is equal to or larger than the threshold. However, a trigger of the monitor screen switching is not always limited to when operation having the operation amount equal to or larger than the threshold is performed. As an example, when the input device 13 is a mouse, the monitor screen can be transitioned to a monitor screen in an immediately superordinate layer by left click and can be transitioned to a monitor screen in an immediately subordinate layer with right click.

The engineering tool 100 according to the first embodiment can perform, by using the engineering tool program 60, with less operation, monitoring display of a variable and a sequence program that cause a deficiency in a unit in which the deficiency occurs.

### Second Embodiment

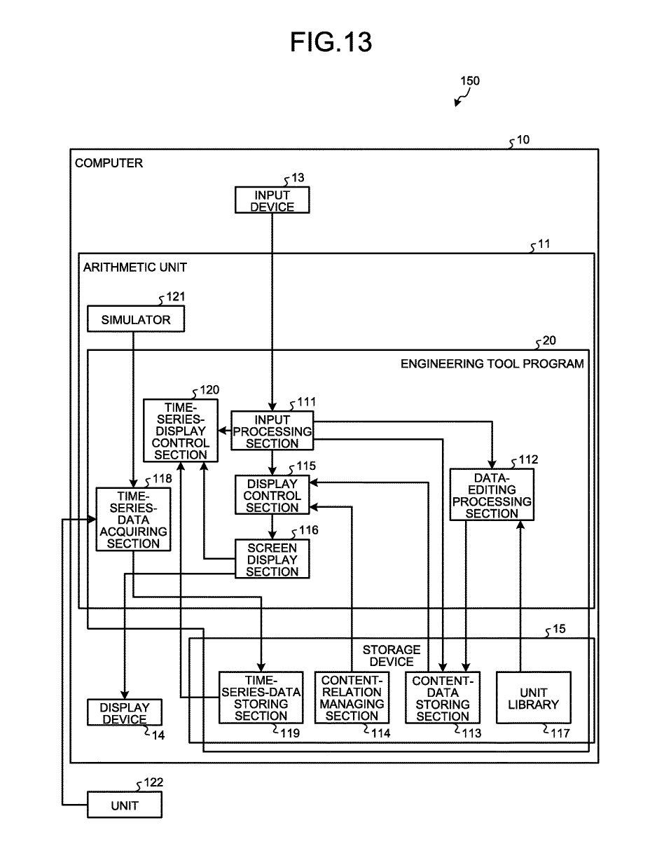

FIG. 13 is a diagram showing a functional configuration of an engineering tool according to a second embodiment of the present invention. An engineering tool 150 according to the second embodiment is different from the engineering tool 100 according to the first embodiment in that the engineering tool 150 includes a time-series-data acquiring section 118 that logs operation data of a unit 122 and causes a time-series-data storing section 119 to store the operation data and causes the time-series-data storing section 119 to store operation data in future calculated by a simulator, a time-series-display control section 120 that performs processing for displaying states in the past and states in future of unit variables and sequence programs, the time-series-data storing section 119 that stores operation data in the past and operation data in future, and a simulator 121 that simulates the operation of a unit and generates operation data in future.

The engineering tool 150 according to the second embodiment includes a function of displaying states in the past and states in future of unit variables and sequence programs. In the following explanation, operation for displaying states in the past and states in future of the unit variables and the sequence programs is explained.

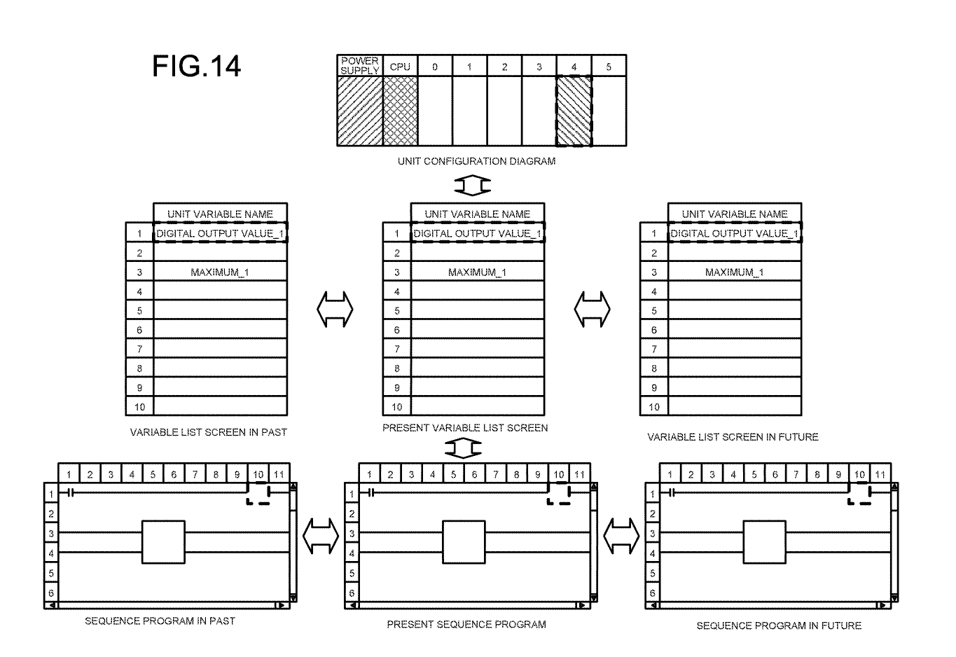

FIG. 14 is a diagram showing screen transition of the engineering tool according to the second embodiment. When the user performs operation for time turn-back of 50%, which is third operation, on the input device 13 on the variable list screen_A, the input processing section 111 recognizes that operation content is the time turn-back of 50%. As a specific example, the time turn-back operation is operation for rotating a mouse wheel of a mouse, which is a part of the input device 13, while depressing a shift key on a keyboard, which is a part of the input device 13. A rotation amount of the mouse wheel is an operation amount indicating magnification of the time turn-back. Because the operation content is the time turn-back operation, the input processing section 111 notifies the time-series-display control section 120 of the operation content.

The time-series-display control section 120 acquires past state data of the variable list screen_A according to a procedure explained below and notifies the screen display section 116 of the past state data.

The time-series-display control section 120 recognizes the time turn-back of 50% as operation for designating a point in time in the middle of a system operation start time and a present point in time. The time-series-display control section 120 reads out operation data at the point in time in the middle of the system operation start time and the present point in time from the time-series-data storing section 119. The time-series-display control section 120 outputs the operation data in the past read out from the time-series-data storing section 119 to the screen display section 116 and causes the display device 14 to display the operation data.

On the other hand, when the user performs operation for time set-forward of 200%, which is fourth operation, on the input device 13 on the variable list screen_A, the input processing section 111 recognizes that operation content is the time set-forward of 200%. As a specific example, the time set-forward operation is operation in which an operator rotates a mouse wheel of a mouse, which is a part of the input device, while depressing a shift key on a keyboard, which is a part of the input device 13. A rotation amount of the mouse wheel is an operation amount indicating magnification of the time set-forward. Because the operation content is the time set-forward operation, the input processing section 111 notifies the time-series-display control section 120 of the operation content.

The time-series-display control section 120 acquires state data in future of the variable list screen_A according to the following procedure and notifies the screen display section 116 of the state data.

First, the time-series-display control section 120 recognizes the time set-forward of 200% as operation for designating a point in time after time same as time from a system operation start time to a present point in time elapses from the present point in time. The time-series-display control section 120 reads out, from the time-series-data storing section 119, operation data at a point in time after elapse of a fixed time from the present point in time. The time-series-display control section 120 outputs, to the screen display section 116, the operation data in future read out from the time-series-data storing section 119 and causes the display device 14 to display the operation data.

When the time turn-back operation of 50% or the time set-forward operation of 200% or more is performed on a program editor screen, similarly, the time-series-display control section 120 reads out operation data in the past or in future from the time-series data 119, outputs the operation data to the screen display section 116, and causes the display device 14 to display the operation data.

In this way, the engineering tool 110 according to the second embodiment can easily display, on the monitor screen, states in the past and states in future of the unit variables and the sequence programs.

### Third Embodiment

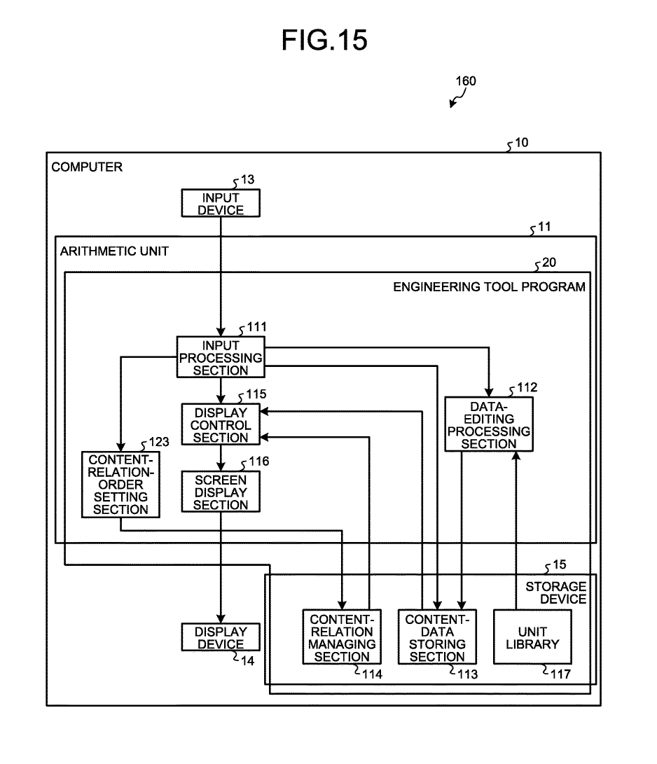

FIG. 15 is a diagram showing a functional configuration of an engineering tool according to a third embodiment of the present invention. An engineering tool 160 according to the third embodiment is different from the engineering tool 100 according to the first embodiment in that the engineering tool 160 includes a content-relation-order setting section 123 that edits content relation management data in the content-relation managing section 114.

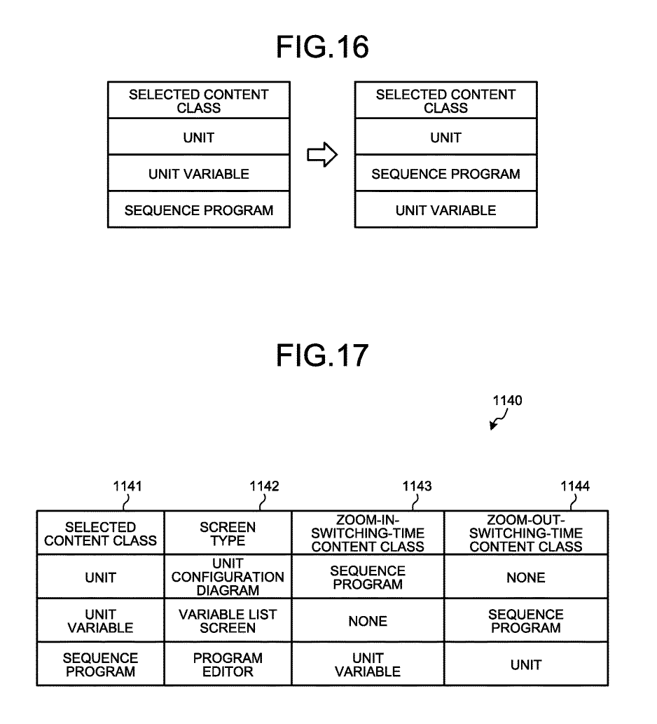

FIG. 16 is a diagram showing a concept of the operation of the content-relation-order setting section included in the engineering tool according to the third embodiment. The content relation management data 1140 shown in FIG. 8 can be regarded as indicating the order of selected content classes selected according to zoom-in operation and zoom-out operation. That is, the content relation management data shown in FIG. 8 indicates that, according to the zoom-in operation, the selected content classes change in the order of a unit, a unit variable, and a sequence program. The content-relation-order setting section 123 performs processing for changing the order of screen transition as shown in FIG. 16. When the content-relation-order setting section 123 performs processing for changing the order of the screen transition, the content relation management data 1140 is changed. FIG. 17 is a diagram showing content relation management data at the time when the content-relation-order setting section of the engineering tool according to the third embodiment changes selected content classes selected by the zoom-in operation in the order of a unit, a sequence program, and a unit variable.

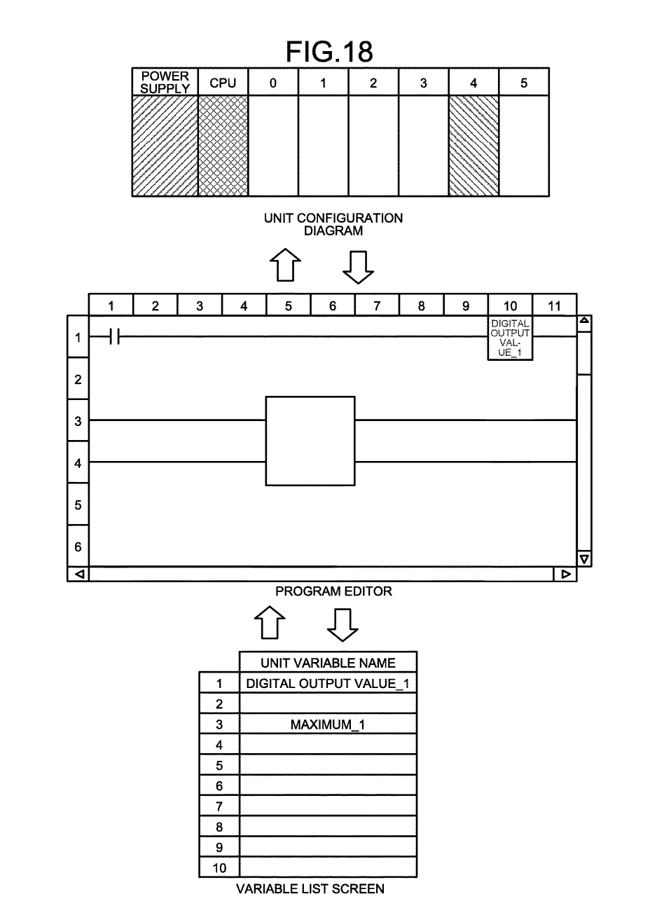

FIG. 18 is a diagram showing screen transition of the engineering tool according to the third embodiment. When the content relation management data is changed, a screen to which a monitor screen is switched when the input processing section detects the zoom-in operation or the zoom-out operation also changes. That is, according to the zoom-in operation on the unit configuration screen_A, the monitor screen transitions to the program editor_A. According to the zoom-in operation in the program editor_A, the monitor screen transitions to the variable list screen_A. According to the zoom-out operation on the variable list screen_A, the monitor screen transitions to the program editor_A. According to the zoom-out operation in the program editor_A, the monitor screen transitions to the unit configuration screen_A.

In the above explanation, as an example, the order of the selected content classes is changed. However, it is also possible to use content classes other than the unit, the unit variable, and the sequence program. As an example, it is possible to change, using, instead of the unit variable, a content class “parameter” configured from a plurality of data for setting an operation state of the unit and referred to in the sequenced program, the selected content classes selected by the zoom-in operation in the order of the unit, the parameter, and the sequence program using. It is also possible to add the content class of the parameter to the unit, the unit variable, and the sequence program and perform the switch display among the four content classes.

In the engineering tool according to the third embodiment, because the order can be set in the content classes, it is possible to display, with less operation amount, the monitor screen having a high display frequency.

The configurations explained in the embodiments indicate examples of the contents of the present invention. The configurations can be combined with other publicly-known technologies. A part of the configurations can be omitted and changed in a range not departing from the spirit of the present invention.

### REFERENCE SIGNS LIST

10 computer
11 arithmetic unit
12 memory
13 input device
14 display device
15 storage device
20 engineering tool program
100, 150, 160 engineering tool
111 input processing section
112 data-editing processing section
113 content-data storing section
114 content-relation managing section
115 display control section
116 screen display section
117 unit library
118 time-series-data acquiring section
119 time-series-data storing section
120 time-series-display control section
121 simulator
122 unit
123 content-relation-order setting section
200 unit configuration diagram
210 programmable logic controller
211 power-supply-unit slot
212 CPU-unit slot
213 general-purpose slot
300 variable list screen
310 list of unit variables
400 program editor
401 editor region
410 sequence program
1131, 1132, 1133, 1134 content data
1140 content relation management data
1141 selected content class
1142 screen type
1143 zoom-in-switching-time content class
1144 zoom-out-switching-time content class
1171 unit name
1172 unit variable

1. An engineering tool program for causing a computer to function as an engineering tool that monitors a programmable logic controller configured by a plurality of units and forming a control system, the engineering tool program causing the computer to function as:
a content-data memory to store data in which content classes indicating classifications of content data to be displayed by the engineering tool and types of monitor screens that display the content data are associated;
a content-relation managing circuitry to store content relation management data indicating a hierarchical relation of layers among different content classes; and
a display controller to change, after first operation is performed, a monitor screen being displayed to a monitor screen corresponding to a content class of an immediately subordinate layer on the basis of the content relation management data and change, after second operation is performed, the monitor screen being displayed to a monitor screen corresponding to a content class of an immediately superordinate layer on the basis of the content relation management data, wherein the content relation management data includes contents of the units, contents of variables indicating states of the units, and contents of sequence programs in which the variables are used.

2. The engineering tool program according to claim 1, wherein the first operation is zoom-in operation having an operation amount equal to or larger than a first threshold set in advance, and the second operation is zoom-out operation having an operation amount equal to or larger than a second threshold set in advance.

3. The engineering tool program according to claim 1, wherein the content classes are types of the units, unit variables indicating internal states of the units, and sequence programs executed by the programmable logic controller.

4. The engineering tool program according to claim 1, further causing the computer to function as:
a time-series-data memory to store operation data in past of the units acquired by logging operation data of the units and operation data in future of the units acquired from a simulator; and
a time-series-display controller to change, after third operation is performed, the monitor screen being displayed to a monitor screen that displays the operation data in the past on the basis of the data stored in the time-series-data storing section and change, after fourth operation is performed, the monitor screen being displayed to a monitor screen that displays the operation data in future on the basis of the data stored in the time-series-data storing section.

5. The engineering tool program according to claim 1, further causing the computer to function as a content-relation-order setter to edit the content relation management data.

6. An engineering tool that monitors a programmable logic controller configured by a plurality of units and forming a control system, the engineering tool comprising:
a content-data memory to store data in which content classes indicating classifications of content data to be displayed by the engineering tool and types of monitor screens that display the content data are associated;
a content-relation managing circuitry to store content relation management data indicating a hierarchical relation of layers among different content classes; and
a display controller to change, after first operation is performed, a monitor screen being displayed to a monitor screen corresponding to a content class of an immediately subordinate layer on the basis of the content relation management data and change, after second operation is performed, the monitor screen being displayed to a monitor screen corresponding to a content class of an immediately superordinate layer on the basis of the content relation management data, wherein the content relation management data includes contents of the units, contents of variables indicating states of the units, and contents of sequence programs in which the variables are used.

7. The engineering tool according to claim 6, wherein the first operation is zoom-in operation having an operation amount equal to or larger than a first threshold set in advance, and the second operation is zoom-out operation having an operation amount equal to or larger than a second threshold set in advance.

8. The engineering tool according to claim 6, wherein the content classes are types of the units, unit variables indicating internal states of the units, and sequence programs executed by the programmable logic controller.

9. The engineering tool according to claim 6, further comprising:
a time-series-data memory to store operation data in past of the units acquired by logging operation data of the units and operation data in future of the units acquired from a simulator; and
a time-series-display controller to change, after third operation is performed, the monitor screen being displayed to a monitor screen that displays the operation data in the past on the basis of the data stored in the time-series-data storing section and change, after fourth operation is performed, the monitor screen being displayed to a monitor screen that displays the operation data in future on the basis of the data stored in the time-series-data storing section.

10. The engineering tool according to claim 6, further comprising a content-relation-order setter to edit the content relation management data.
